(19) United States
(12) Patent Application Publication
(10) Pub. No.: US 2026/0168766 A1
(43) Pub. Date: Jun. 18, 2026

(54) Novel Design Of Reflex Sight Reticles

(71) Applicant: Strike IP LLC, Las Vegas, NV (US)

(72) Inventor: Shanyao Lee, Las Vegas, NV (US)

(73) Assignee: Strike IP LLC, Las Vegas, NV (US)

(21) Appl. No.: 19/390,502

(22) Filed: Nov. 15, 2025

Related U.S. Application Data
(60) Provisional application No. 63/735,190, filed on Dec. 17, 2024.

(51) Int. Cl. F41G 1/34; F41G 1/42; G02B 23/16

(52) U.S. Cl. CPC F41G 1/345; F41G 1/42; G02B 23/16

(57) ABSTRACT

An apparatus implementable on a firearm includes a reflex sight having a single light source configured to display each reticle of multiple reticles one at a time. The reflex sight also has a switch configured to, when activated, switch the single light source from displaying the first reticle to displaying the second reticle.

### CROSS-REFERENCE TO RELATED PATENT APPLICATION(S)

The present disclosure is part of a non-provisional application claiming the priority benefit of U.S. Patent Application 63/735,190, filed 17 Dec. 2024, the content of which being incorporated by reference in its entirety.

### TECHNICAL FIELD

The present disclosure is generally related to firearm accessories and, more particularly, to novel designs of reflex sigh reticles.

### BACKGROUND

Unless otherwise indicated herein, approaches described in this section are not prior art to the claims listed below and are not admitted as prior art by inclusion in this section.

Reflex sights typically provide a fixed magnification level with uncomplicated reticles. In situations where a shooter requires increased magnification for targeting at extended distances, an additional, or supplementary, optic with higher magnification (e.g., 3×) may be attached to the rear end of the reflex sight to provide increased magnification. This supplementary optic allows for precision aiming at distant targets.

It is noteworthy that the reticle of the reflex sight is specifically designed and calibrated for the default magnification level. Consequently, when the supplementary optic with a higher magnification is used in addition to the reflex sight, the original reticle of the reflex sight may lose its accuracy, thereby negatively impacting the alignment and overall aiming performance. Therefore, there is a need for a solution of novel designs of reflex sigh reticles.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In view of the aforementioned issues, an objective of the present disclosure is to propose innovative designs of novel designs of reflex sigh reticles. It is believed that the proposed designs can avoid or otherwise minimize aforementioned issue associated with existing reflex sights.

In one aspect, an apparatus implementable on a firearm (e.g., an AR-15 or AR-10 style firearm) may include a reflex sight comprising a single light source configured to display each reticle of multiple reticles one at a time.

In another aspect, an apparatus implementable on a firearm (e.g., an AR-15 or AR-10 style firearm) may include a reflex sight having a single light source configured to display each reticle of multiple reticles one at a time. The reflex sight may also have a switch configured to, when activated, switch the single light source from displaying the first reticle to displaying the second reticle.

In yet another aspect, a method of operation of a reflex sight installed on a firearm may involve displaying a first reticle by a single light source of a reflex sight. The method may also involve switching the single light source to display a second reticle different from displaying the first reticle responsive to a switch of the reflex sight being activated due to an optics being installed on the firearm.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example apparatus under a proposed scheme in accordance with the present disclosure.

FIG. 2 is a diagram of an example apparatus installed on a firearm under a proposed scheme in accordance with the present disclosure.

FIG. 3 is a diagram of an example design under a proposed scheme in accordance with the present disclosure.

FIG. 4 is a diagram of an example design under a proposed scheme in accordance with the present disclosure.

FIG. 5 is a diagram of an example process under a proposed scheme in accordance with the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

The position terms used in the present disclosure, such as “front”, “forward”, “rear”, “back”, “top”, “bottom”, “left”, “right”, “head”, “tail” or the like assume a firearm in the normal firing position, with the firearm being in a position in which the longitudinal axis of the barrel of the firearm runs generally horizontally and the direction of firing points “forward” away from the operator or user of the firearm. The same convention applies for the direction statements used herein.

As used herein, the terms “proximal” and “proximally” may denote “forward” and “forwardly” with respect to the firearm, and the terms “distal” and “distally” may denote “rearward” and “rearwardly” with respect to the firearm. As used herein, the verb “to comprise” in this description, claims, and other conjugations are used in its non-limiting sense to mean those items following the word are included, but items not specifically mentioned are not excluded. As used herein, the word “forward” means moving in the direction that the projectile moves during firing a firearm. As used herein, the word “proximal” means closer to the reference point, in this case, the shooter. As used herein, the word “distal” means farther to the reference point, in this case, the shooter. Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5). All dimensions given herein are by way of examples to better illustrate the present disclosure embodiments and shall not be construed to limit the dimensions of the present disclosure embodiments to the given numeric values.

### Overview

Under the various proposed schemes in accordance with the present disclosure, a novel design of reflex sight may utilize a single light source for the reflex sight, which may be a light-emitting diode (LED), organic LED (OLED) or a similar light source that is capable of displaying images of multiple reticles. In operation, a user may zero a first reticle at a default 1× magnification, with an impact point of the first reticle situated or positioned at a first or center position. Upon attaching a higher-magnification optics to a rear end of the reflex sight and switching to a second reticle, which is designed for increased magnification, the impact point of the second reticle may be situated or positioned at a second or lower position which is below the first or center position of the impact point of the first reticle. This design accommodates the shift in the line of sight associated with higher magnification levels, ensuring precise targeting with each reticle option. Under a proposed scheme in accordance with the present disclosure, the reflex sight may include a switch, which may be a mechanical switch or an electronic sensor, configured to activate switching of the reticles from one reticle to another (e.g., from the first reticle to the second reticle) when engaged by a higher-magnification optics (e.g., when the higher-magnification optics is attached to the firearm and next to the reflex sight).

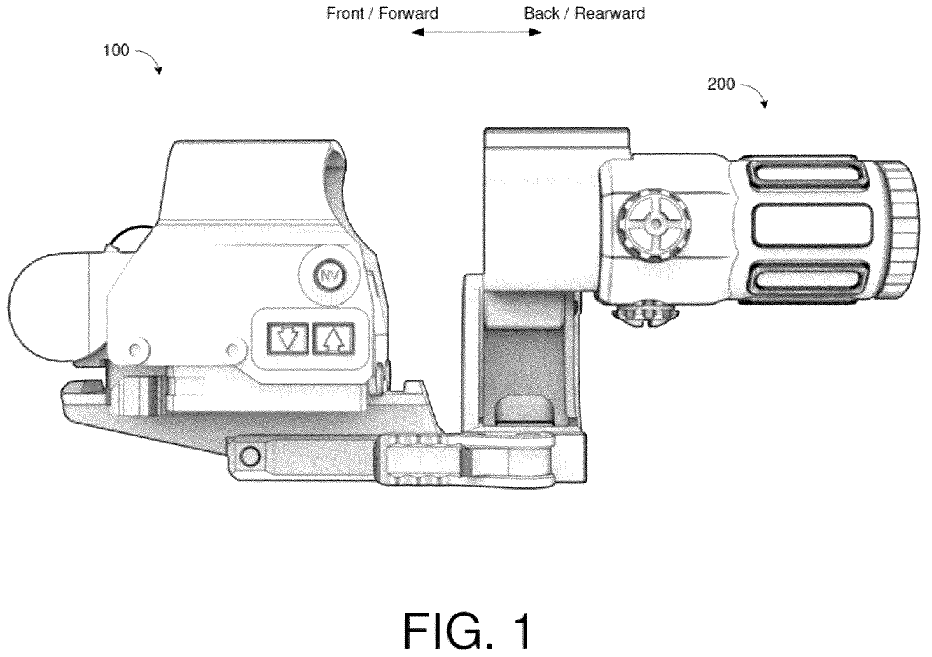

FIG. 1 illustrates an example apparatus 100 under a proposed scheme in accordance with the present disclosure. Apparatus 100 may be a power reflex sight under the proposed scheme. The reflex sight may provide a default 1× magnification (or no magnification) and may be used in conjunction with a higher-magnification optics 200, which provides a higher magnification (e.g., 3× magnification).

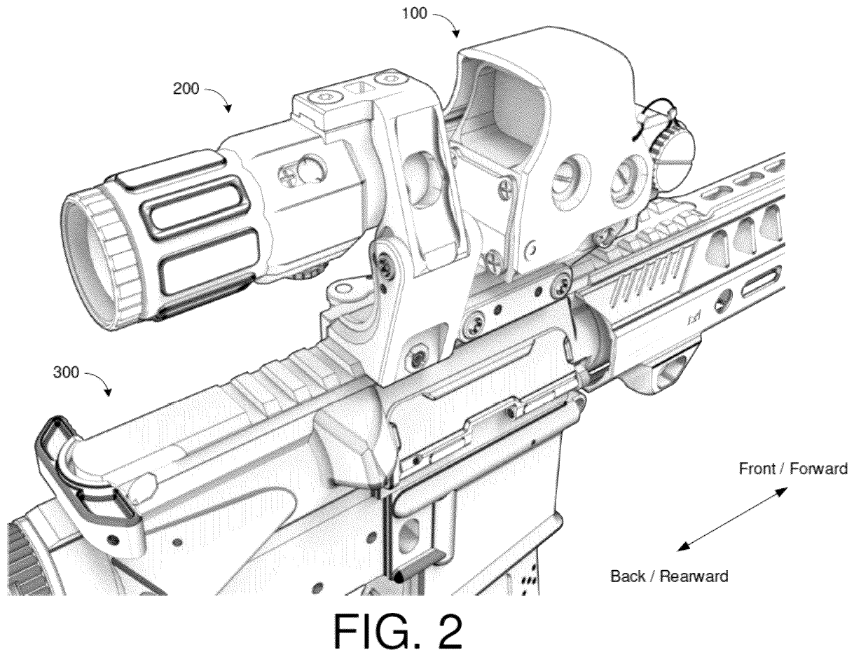

FIG. 2 illustrates an example apparatus 100 installed on a firearm under a proposed scheme in accordance with the present disclosure. Specifically, FIG. 2 shows apparatus 100, as a power reflex sight, and a higher-magnification optics 200 being installed or otherwise attached to a firearm (e.g., on a Picatinny rail of an AR15-style firearm).

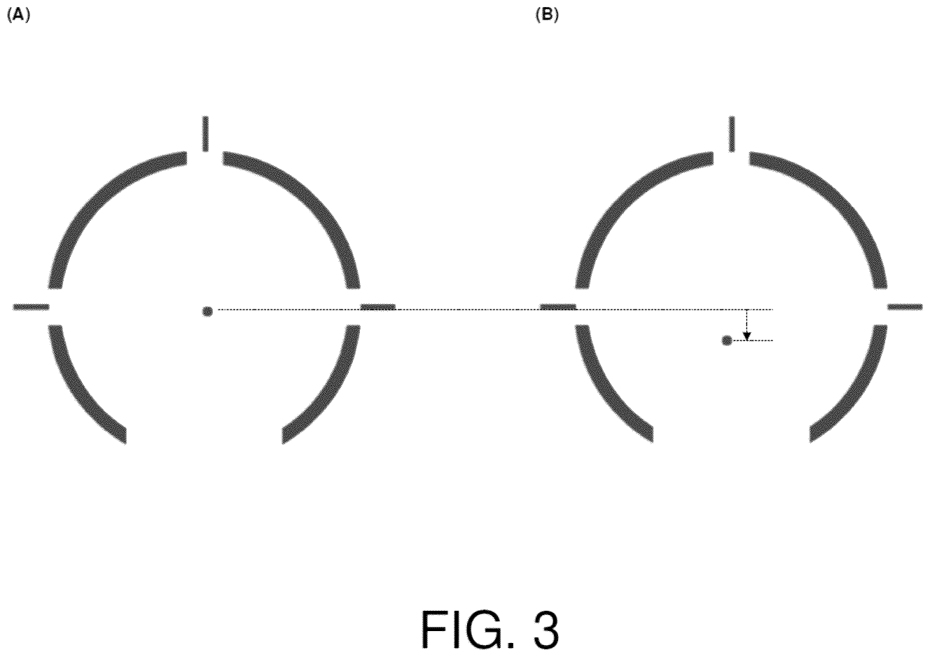

FIG. 3 illustrates an example design under a proposed scheme in accordance with the present disclosure. Part (A) of FIG. 3 shows a first reticle of apparatus 100 designed for a default 1× magnification. Part (B) of FIG. 3 shows a second reticle of apparatus 100 designed for a higher (e.g., 3× or another value) magnification. As shown in FIG. 3, an impact point of the first reticle may be situated or positioned at a first or center position (relative to a surrounding ring), and an impact point of the second reticle may be situated or positioned at a second or lower position which is below the first or center position of the impact point of the first reticle. Under the proposed scheme, only one of the first reticle and the second reticle may be displayed at a given time during operation of apparatus 100. In other words, both the first and second reticles may not be displayed simultaneously during operation of apparatus 100.

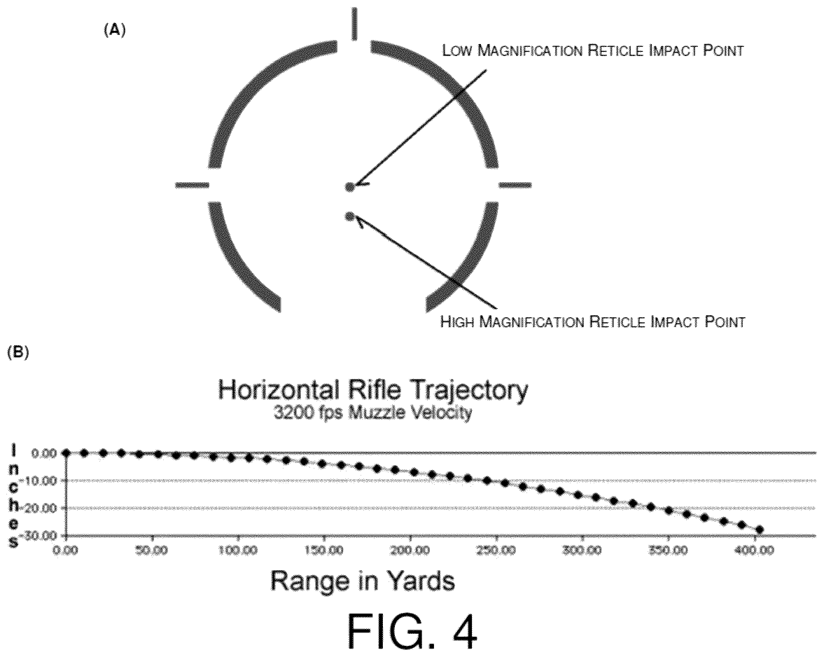

FIG. 4 illustrates an example design under a proposed scheme in accordance with the present disclosure. Part (A) of FIG. 4 shows the impact point of the first reticle (or lower-power magnification reticle) and the impact point of the second reticle (or higher-power magnification reticle) of apparatus 100, although normally these two reticles may not be displayed at the same time during operation. As an implementational example, when a shooter zeros the reflex sight at 100 yards, the bullet may accurately hit the intended target at that distance. When aiming at a more distant target, such as 300 yards, the shooter may attach a high-magnification optics 200 to the rear of apparatus 100 (the reflex sight). The increased magnification may enlarge the 300-yard target on the screen. However, as shown in part (B) of FIG. 4, due to gravity the bullet trajectory may experience a drop that causes the impact point to be lower compared to that of the 100-yard target. To address this issue, a switchable reticle sight with a lower impact point, such as apparatus 100, becomes essential. This allows the shooter to seamlessly transition to another reticle better suited for the higher magnification setting, thereby compensating for the bullet drop and ensuring accurate targeting at extended distances.

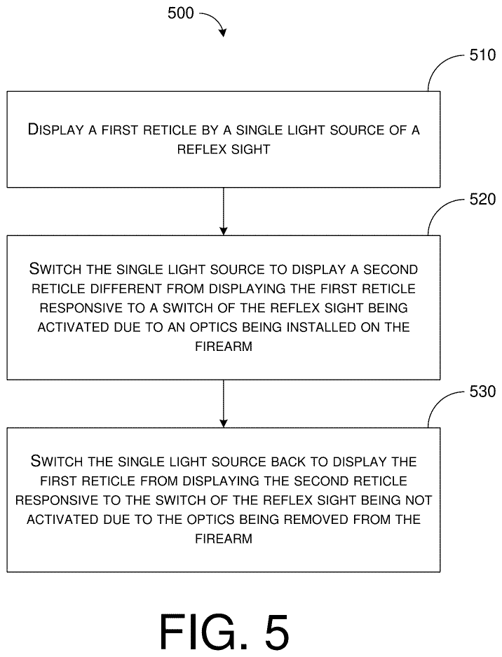

FIG. 5 illustrates an example process 500 under a proposed scheme in accordance with the present disclosure. Process 500 may pertain to a method of operation of a reflex sight installed on a firearm (e.g., an AR-15 or AR-10 style firearm). Process 500 may involve a number of operations and/or actions, as represented by blocks 510, 520 and 530. Process 500 may begin at 510.

At 510, process 500 may involve displaying a first reticle by a single light source of a reflex sight. Process 500 may proceed from 510 to 520.

At 520, process 500 may involve switching the single light source to display a second reticle different from displaying the first reticle responsive to a switch of the reflex sight being activated due to an optics being installed on the firearm. Process 500 may proceed from 520 to 530.

At 530, process 500 may involve switching the single light source back to display the first reticle from displaying the second reticle responsive to the switch of the reflex sight being not activated due to the optics being removed from the firearm.

In some implementations, the multiple reticles may include a first reticle and a second reticle such that: (a) a first impact point of the first reticle is situated or positioned at a first or center position; and (b) a second impact point of the second reticle is situated or positioned at a second or lower position which is below the first or center position of the first impact point of the first reticle.

In some implementations, the switch may include a mechanical mechanism that is activated when engaged by a supplementary optics installed on the firearm.

In some implementations, the switch may include an electronic sensor that is activated when engaged by a supplementary optics installed on the firearm.

In some implementations, the single light source may include LED.

In some implementations, the single light source may include OLED.

### Example Implementations

In view of the above, the proposed designs of a reflex sight may be implemented in many ways. For illustrative purposes and without limiting the scope of the present disclosure, a few example implementations of the proposed design are described below.

In one aspect, an apparatus implementable on a firearm (e.g., an AR-15 or AR-10 style firearm) may include a reflex sight comprising a single light source configured to display each reticle of multiple reticles one at a time.

In some implementations, the multiple reticles may include a first reticle and a second reticle such that: (a) a first impact point of the first reticle is situated or positioned at a first or center position; and (b) a second impact point of the second reticle is situated or positioned at a second or lower position which is below the first or center position of the first impact point of the first reticle.

In some implementations, the reflex sight may further include a switch that, when activated, switches the single light source from displaying the first reticle to displaying the second reticle.

In some implementations, the switch may include a mechanical mechanism that is activated when engaged by a supplementary optics installed on the firearm.

In some implementations, the switch may include an electronic sensor that is activated when engaged by a supplementary optics installed on the firearm.

In some implementations, the single light source may include LED.

In some implementations, the single light source may include OLED.

In another aspect, an apparatus implementable on a firearm (e.g., an AR-15 or AR-10 style firearm) may include a reflex sight having a single light source configured to display each reticle of multiple reticles one at a time. The reflex sight may also have a switch configured to, when activated, switch the single light source from displaying the first reticle to displaying the second reticle.

In some implementations, the multiple reticles may include a first reticle and a second reticle such that: (a) a first impact point of the first reticle is situated or positioned at a first or center position; and (b) a second impact point of the second reticle is situated or positioned at a second or lower position which is below the first or center position of the first impact point of the first reticle.

In some implementations, the switch may include a mechanical mechanism that is activated when engaged by a supplementary optics installed on the firearm.

In some implementations, the switch may include an electronic sensor that is activated when engaged by a supplementary optics installed on the firearm.

In some implementations, the single light source may include LED.

In some implementations, the single light source may include OLED.

In yet another aspect, a method of operation of a reflex sight installed on a firearm (e.g., an AR-15 or AR-10 style firearm) may involve displaying a first reticle by a single light source of a reflex sight. Additionally, the method may involve switching the single light source to display a second reticle different from displaying the first reticle responsive to a switch of the reflex sight being activated due to an optics being installed on the firearm. Moreover, the method may involve switching the single light source back to display the first reticle from displaying the second reticle responsive to the switch of the reflex sight being not activated due to the optics being removed from the firearm.

In some implementations, the multiple reticles may include a first reticle and a second reticle such that: (a) a first impact point of the first reticle is situated or positioned at a first or center position; and (b) a second impact point of the second reticle is situated or positioned at a second or lower position which is below the first or center position of the first impact point of the first reticle.

In some implementations, the switch may include a mechanical mechanism that is activated when engaged by a supplementary optics installed on the firearm.

In some implementations, the switch may include an electronic sensor that is activated when engaged by a supplementary optics installed on the firearm.

In some implementations, the single light source may include LED.

In some implementations, the single light source may include OLED.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or single terms herein, those having skill in the art can translate from the plural to the single and/or from the single to the plural as is appropriate to the context and/or application. The various single/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. An apparatus implementable on a firearm, comprising:
a reflex sight comprising a single light source configured to display each reticle of multiple reticles one at a time.

2. The apparatus of claim 1, wherein the multiple reticles comprise a first reticle and a second reticle, and wherein:
a first impact point of the first reticle is situated or positioned at a first or center position; and
a second impact point of the second reticle is situated or positioned at a second or lower position which is below the first or center position of the first impact point of the first reticle.

3. The apparatus of claim 2, wherein the reflex sight further comprises a switch that, when activated, switches the single light source from displaying the first reticle to displaying the second reticle.

4. The apparatus of claim 3, wherein the switch comprises a mechanical mechanism that is activated when engaged by a supplementary optics installed on the firearm.

5. The apparatus of claim 3, wherein the switch comprises an electronic sensor that is activated when engaged by a supplementary optics installed on the firearm.

6. The apparatus of claim 1, wherein the single light source comprises a light-emitting diode (LED).

7. The apparatus of claim 1, wherein the single light source comprises an organic light-emitting diode (OLED).

8. An apparatus implementable on a firearm, comprising:
a reflex sight comprising a single light source configured to display each reticle of multiple reticles one at a time, the reflex sight further comprising a switch configured to, when activated, switch the single light source from displaying the first reticle to displaying the second reticle.

9. The apparatus of claim 8, wherein the multiple reticles comprise a first reticle and a second reticle, and wherein:
a first impact point of the first reticle is situated or positioned at a first or center position; and
a second impact point of the second reticle is situated or positioned at a second or lower position which is below the first or center position of the first impact point of the first reticle.

10. The apparatus of claim 8, wherein the switch comprises a mechanical mechanism that is activated when engaged by a supplementary optics installed on the firearm.

11. The apparatus of claim 8, wherein the switch comprises an electronic sensor that is activated when engaged by a supplementary optics installed on the firearm.

12. The apparatus of claim 8, wherein the single light source comprises a light-emitting diode (LED).

13. The apparatus of claim 8, wherein the single light source comprises an organic light-emitting diode (OLED).

14. A method of operation of a reflex sight installed on a firearm, comprising:
displaying a first reticle by a single light source of a reflex sight; and
switching the single light source to display a second reticle different from displaying the first reticle responsive to a switch of the reflex sight being activated due to an optics being installed on the firearm.

15. The method of claim 14, further comprising:
switching the single light source back to display the first reticle from displaying the second reticle responsive to the switch of the reflex sight being not activated due to the optics being removed from the firearm.

16. The method of claim 14, wherein:
a first impact point of the first reticle is situated or positioned at a first or center position; and
a second impact point of the second reticle is situated or positioned at a second or lower position which is below the first or center position of the first impact point of the first reticle.

17. The method of claim 14, wherein the switch comprises a mechanical mechanism that is activated when engaged by a supplementary optics installed on the firearm.

18. The method of claim 14, wherein the switch comprises an electronic sensor that is activated when engaged by a supplementary optics installed on the firearm.

19. The method of claim 14, wherein the single light source comprises a light-emitting diode (LED).

20. The method of claim 14, wherein the single light source comprises an organic light-emitting diode (OLED).
